(19) United States
(12) Patent Application Publication
(10) Pub. No.: US 2014/0230698 A1
(43) Pub. Date: Aug. 21, 2014

(54) PROCESS FOR THE BODY-HYDROPHOBIZATION OF BUILDING MATERIALS COMPRISING SOLID ORGANOSILICON COMPOUNDS

(71) Applicant: Wacker Chemie AG, Munich (DE)

(72) Inventors: Michael Stepp, Ueberackern (AT); Herbert Koller, Emmerting (DE); Daniel Schildbach, Altoetting (DE)

(73) Assignee: Wacker Chemie AG, Munich (DE)

(21) Appl. No.: 14/351,505

(22) PCT Filed: Oct. 1, 2012
(86) PCT No.: PCT/EP2012/069302

§ 371 Date: Apr. 11, 2014

(30) Foreign Application Priority Data
Oct. 11, 2011 (DE) 10 2011 084 301.9

(51) Int. Cl. C04B 24/42

(52) U.S. Cl. CPC C04B 24/42
USPC 106/781; 556/482; 106/806

(57) ABSTRACT

Body-hydrophobing of mineral building compositions prepared from water curable mineral materials such as cement and plaster are obtained by admixing into the curable composition an organosilicon compound prepared by reacting a hydrocarbylhalosilane or hydrocarbylhydrocarbyloxysilane with a gylcol or polyglycol in a mol ratio of halo or hydrocarbyloxy radicals to hydroxyl radicals of 0.3 to 1.3. The organosilicon compounds are solid at 20° C.

The invention relates to a process for the body-hydrophobization of building materials with organosilicon compounds which are solid at 20° C., and to building material mixtures which comprise these organosilicon compounds.

Liquid, water-soluble or water-dispersible hydrophobizing compositions for mineral building materials, based on silicones, are long-established. In particular, alkali metal organosiliconates such as potassium methylsiliconate have already been in use for decades for hydrophobization, more particularly for the impregnation of mineral building materials. On account of their ready solubility in water, they can be applied in the form of an aqueous solution to solids, where following evaporation of water, under the influence of usually naturally occurring carbon dioxide, they form firmly adhering, durably water-repellent surfaces. In contrast, in the case of body-hydrophobization, the aqueous solution of the organosiliconate is mixed, optionally after further dilution, with the aqueous slurry of, for example, a gypsum-based building material. After the gypsum building material has hardened and dried, its water absorption is greatly reduced as compared with the unhydrophobized building material. The advantage of the body-hydrophobization of, for example, gypsum is that the building material not only is surrounded by a hydrophobic zone but is also water-repellent through and through. This is especially important for building materials such as gypsum with a propensity to water solubility, or if the building material is cut into pieces after the water repellency treatment. This process is employed, for example, in the production of gypsum plasterboard, gypsum wallboarding panels, or gypsum fiberboard.

Gypsum plasters and gypsum filling compounds or gypsum-based screed systems or tile adhesives, however, are supplied to the building site as powders, in bags or silos, and are made up only on the building site by stirring with the mixing water. For application in gypsum plasters, gypsum filling compounds, gypsum repair filler powders, gypsum-based tile adhesives, and similar mineral building materials, therefore, a solid hydrophobizing agent is required that can be added to the ready-to-use dry mix and which develops its hydrophobizing effect in a short time only on addition of water during application on site, such as on the building site, for example. This is called dry-mix application.

Solid alkali metal siliconates are described for use as a dry-mix additive for the hydrophobization of gypsum in U.S. Pat. No. 2,803,561, for example, and of cementitious tile adhesives in DE A 10107614, for example. On account of their high alkalinity, however, they have a strongly irritant effect. As a consequence, they lie behind considerable health risks associated with handling, such as irritation of the airways by dust inhalation, with development of pulmonary edema or even irreversible injury to the eyes.

The majority of conventional, neutral dry-mix hydrophobizing agents in accordance with the current state of the art are supported systems, which means that a hydrophobizing agent which is in fact in liquid form, such as an active silane and/or siloxane ingredient, for example, is applied to a support material which is more or less chemically inert. The amount of hydrophobizing agent applied in this case is only such as to produce a dry and free-flowable powder. The support material may be inorganic in nature, examples being silicas and silicates, or organic in nature, examples being polyvinyl alcohols, as described in WO 2010052201. The liquid hydrophobizing agent develops its effect as a result of being mixed with the mixing water intensively. Conventional dry-mix hydrophobizing agents have a series of disadvantages. Particularly in the case of products which contain alkylsiloxanes, the problem occurs that the high hydrophobicity of the powders and premature migration of the hydrophobizing agent onto the building material which is still to be mixed with water results in a delayed initial miscibility. As a result, in addition to the loss of time, unwanted dust is formed from the building material as a result of the delayed water wetting. Conventional dry-mix hydrophobizing agents which instead contain hydrolysable (alkoxy)silanes give off volatile constituents in use that may be injurious to health, such as methanol, for example (see WO 2010052201). It is known, furthermore, that the active silane ingredients in supported systems may evaporate even during the spray-drying operation, but also in the course of subsequent storage. This reduces the active ingredient content, moreover.

Attempts have been made to eliminate this disadvantage by replacing the major part of the low molecular mass alkoxy radicals with high-boiling glycols. In this context it has in each case been assumed that a high water-solubility was a prerequisite for the hydrophobizing effect, such solubility being realizable only by means of high proportions of glycol. The products described have therefore customarily been liquids or aqueous solutions thereof, with correspondingly high glycol concentrations.

U.S. Pat. No. 2,887,467 A describes, for example, the synthesis of water-soluble silsesquioxanes by reaction of water-insoluble silsesquioxanes with ethylene glycol at temperatures of about 150° C.; there must be at least three equivalents of ethylene glycol present per silicon atom. The products obtained accordingly are suitable in principle for use as hydrophobizing agents.

DE 1076946 describes a process for preparing liquid, water-soluble reaction products by reaction of methyl- and/or ethylalkoxysilanes (at least 50 mol % monoalkyltrialkoxysilanes) with ethylene glycol; more than one hydroxyl group of the ethylene glycol is used per alkoxy group. Serving as catalyst for the transalkoxylation are residues of HCl (from the preparation of the alkoxysilane). The aqueous solutions serve for the hydrophobization of surfaces, especially of masonry and glass fibers. The liquids, however, cannot be used as a dry-mix additive.

Replacing ethylene glycol with propylene glycol produces water-insoluble products, and temperatures of >100° C. also lead to water-insoluble products of low serviceability.

The products described according to DE 1076946 AS and U.S. Pat. No. 2,887,467 A are water-soluble hydrophobizing impregnating compositions. They are characterized in that a mandatory at least three-fold excess of polar substituents per silicon atom is necessary in order to obtain a suitable hydrophobizing agent. It is not the polar group that is hydrophobizing here, but rather the silicon-based component. As a result of the high proportion of polar substituents, which for effective hydrophobization must be eliminated at least to an extent that the resulting hydrophobizing product is no longer water-soluble, high quantities of hydrophobizing agent must be added in order to obtain good effects. Eliminating the polar groups requires the establishment of suitable reaction conditions for the hydrolysis and condensation, and this restricts the usefulness of these products.

In DE 102004056977 and also WO2006/097206, liquid, water-soluble or self-emulsifying reaction products of alkyltrihalosilane or alkyltrialkoxysilane with 2.0-2.99 mol equivalents of glycol (per mol equivalent of silane) are likewise used, optionally in combination with bases (alkali metal/alkaline earth metal oxides/hydroxides) as hydrophobizing additives for water-repellent gypsum blends or for the hydrophobizing impregnation and priming of mineral substances, of wood, paper, and textiles.

U.S. Pat. No. 2,441,066 describes an operation for the reaction of organohalosilanes with compounds which contain at least two alcoholic hydroxyl groups. The silane:polyalcohol ratio by weight ranges from 1.4:1 to 3.3:1. From di- and trihalosilanes, predominantly insoluble solids are obtained. The products may serve as impregnating compositions.

The invention provides a process for the body-hydrophobization of substrates with organosilicon compounds O which are solid at 20° C. and preparable by reaction of a molar equivalent of silane S which is selected from hydrocarbyltrihalosilane, hydrocarbyltrihydrocarbyloxysilane, or mixtures thereof, or their partial hydrolysates with polyhydroxy compounds P, in a molar ratio such that per mol equivalent of halo or hydrocarbyloxy radical there are 0.3 to 1.3 mol equivalents of hydroxyl radicals present.

Contrary to the prior art cited above, it has been found that by the reaction of 1 mol equivalent of silane S with polyhydroxy compounds P, in a molar ratio where per mol equivalent of halo or hydrocarbyloxy radical there are 0.3-1.3 mol equivalents of hydroxyl radicals present, stable products are obtained which produce very good hydrophobization. This is all the more surprising given that these solid products exhibit only low solubility in water. Their advantage is that they can be utilized as solids in ready-to-use dry-mix building material mixtures. These organosilicon compounds O are more efficient than, for example, the glycol-functional siloxanes of WO 2006/097206 (where there are 1.33-1.93 hydroxyl radicals present per halo or hydrocarbyloxy radical), since the amounts of polar groups which must be eliminated in order for the hydrophobicity to develop are smaller and conversely, accordingly, the amount of hydrophobizing siloxane fraction is larger. As a result of this, moreover, there is a reduction in the amount of volatile organic constituents given off when these products are employed.

The hydrocarbyl radicals of the silane S are preferably optionally substituted C₁-C₁₅ hydrocarbyl radicals. Examples of the C₁-C₁₅ hydrocarbyl radicals are alkyl radicals, such as the methyl, ethyl, n-propyl, isopropyl, n-butyl, isobutyl, tert-butyl, n-pentyl, isopentyl, neopentyl, tert-pentyl radical; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; alkenyl radicals, such as the vinyl and the allyl radical; cycloalkyl radicals, such as cyclopentyl, cyclohexyl, cycloheptyl radicals, and methylcyclohexyl radicals; aryl radicals, such as the phenyl, naphthyl, anthryl and phenanthryl radical; alkaryl radicals, such as o-, m-, and p-tolyl radicals; xylyl radicals and ethylphenyl radicals; aralkyl radicals, such as the benzyl radical, the alpha- and the β-phenylethyl radical.

Examples of substituted C₁-C₁₅ hydrocarbyl radicals are alkyl radicals substituted by fluorine, chlorine, bromine, and iodine atoms, such as the 3,3,3-trifluoro-n-propyl radical, the 2,2,2,2′,2′,2′-hexafluoroisopropyl radical, the heptafluoroisopropyl radical, and haloaryl radicals, such as the o-, m-, and p-chlorophenyl radical, where silane S is a hydrocarbyloxysilane, alkyl radicals substituted by amino functions, such as the 3-aminopropyl radical, the N-phenylaminomethyl radical, the N-(2-aminoethyl)-3-aminopropylradical, the N-morpholinomethyl radical, the N-octylaminomethyl radical, alkyl radicals substituted by thiol functions such as the thiopropyl radical, alkyl radicals substituted by epoxy functions such as the glycidyloxypropyl radical, and the ethylcyclohexene oxide radical. Particularly preferred are the unsubstituted C₁-C₈ alkyl radicals, more particularly the methyl radical and the ethyl radical.

The hydrocarbyloxy radicals of the silane S are preferably C₁-C₁₅ hydrocarbyloxy radicals. Examples of the C₁-C₁₅ hydrocarbyloxy radicals are the above C₁-C₁₅ hydrocarbyl radicals which are bonded to the silicon atom via a divalent oxygen atom. Particularly preferred are the unsubstituted C₁-C₃ alkyl radicals, more particularly the methyl radical and the ethyl radical.

The halo radicals of the silane S are preferably chloro radicals.

The silane S may further comprise small proportions, preferably not more than 5 mol %, more particularly not more than 2 mol %, of silanes selected from dihydrocarbyldihalosilane, trihydrocarbylhalosilane, tetrahalosilane, dihydrocarbyldihydrocarbyloxysilane, trihydrocarbylhydrocarbyloxysilane, and tetrahydrocarbyloxysilane.

The silane S may also further comprise small proportions, preferably not more than 5 mol %, more particularly not more than 2 mol %, of siloxanes, which form by hydrolysis from the silane S.

The silane S may also further comprise small proportions, preferably not more than 5 mol %, more particularly not more than 2 mol %, of disilanes, from—for example—distillation residues from the preparation of methylchlorosilane.

Besides halo radicals and hydrocarbyloxy radicals, the silane S may comprise small proportions, preferably not more than 10 mol %, more particularly not more than 5 mol %, of Si-bonded hydrogen.

The polyhydroxy compound P preferably comprises a linear or branched, monomeric or oligomeric C₂-C₆ glycol, and also mixed glycols, more particularly C₂-C₄ glycol with a total of not more than 40 carbon atoms, preferably not more than 25, more particularly not more than 15 carbon atoms, tri-, tetra-, penta-, and hexa-hydroxy compounds having 3 to 12 carbon atoms, and C₂-C₁₂ hydroxycarboxylic acids.

Particularly preferred for possible use among the glycols are ethylene glycol or its oligomers, propylene glycol or its oligomers, and also mixed glycols having propylene glycol and ethylene glycol units. The oligomers preferably have not more than six, more particularly not more than three monomer units. Examples of branched or linear C₂-C₂₅ glycol radicals are alpha, omega-dihydroxy-functional glycols such as ethylene glycol, propylene glycol (=1,2-propanediol), 1,3-propanediol, 1,4-butanediol, 1,5-pentanediol, 1,6-hexanediol, neopentyl glycol, pinacol, di-, tri-, and tetraethylene glycol, di-, tri-, and tetrapropylene glycol, alpha, omega-dihydroxy-functional mixed glycols of 1-5 ethylene glycol units and 1-5 propylene glycol units, and also mixtures thereof, and bis-(hydroxymethyl) urea. Particularly preferred are propylene glycol and ethylene glycol, more particularly propylene glycol.

Particularly preferred among the tri-, tetra-, penta-, and hexa-hydroxy compounds having 3 to 12 carbon atoms are linear or branched tri-, tetra-, penta-, and hexa-hydroxy compounds having 3 to 12 carbon atoms. Examples are glycerol, 1,2,4-butanetriol, 1,1,1-tris(hydroxymethyl)ethane, pentaerythritol, meso-erythritol, D-mannitol, saccharides such as D-(+)-mannose, D-(+)-glucose, and D-fructose. It is also possible, furthermore, for the condensation products thereof, di- and polysaccharides such as D-(+)-sucrose, cyclodextrins, cellulose and starch, and also derivatives thereof, examples being their methyl, ethyl, and hydroxyethyl derivates, or partly or fully hydrolyzed polyvinyl acetates to be used.

Particularly preferred among the C₂-C₁₂ hydroxycarboxylic acids, preferably C₂-C₈ hydroxycarboxylic acids, are aromatic and linear or branched hydroxyalkylcarboxylic acids, such as salicylic acid, mandelic acid, 4-hydroxybenzoic acid, 2,4-dihydroxybenzoic acid, 3,5-dihydroxybenzoic acid, glycolic acid, lactic acid, 2,2-bis-(hydroxymethyl)propionic acid, tartaric acid, citric acid, 3-hydroxybutyric acid, 2-hydroxyisobutyric acid; particular preference is given to linear or branched hydroxyalkylcarboxylic acids, more particularly lactic acid.

Preference is given to using at least 0.5 mol equivalent, more preferably at least 0.7, more particularly at least 0.9, and preferably not more than 1.3, more preferably not more than 1.2, more particularly not more than 1.1, hydroxyl groups, originating from the polyhydroxy compound P, per mol equivalent of halo or hydrocarbyloxy radical in silane S.

Preference is given to using silanes S with hydrocarbyloxy radical, more preferably alkyltrialkoxysilanes. Examples are methyltrimethoxysilane, ethyltrimethoxysilane, n-propyltrimethoxysilane, isopropyltrimethoxysilane, n-butyltrimethoxysilane, 2-methyl-1-propyltrimethoxysilane, 2-butyltrimethoxysilane, cyclohexyltrimethoxysilane, 2-cyclohexyl-1-ethyltrimethoxysilane, n-hexyltrimethoxysilane, isohexyltrimethoxysilane, n-heptyltrimethoxysilane, n-octyltrimethoxysilane, isooctyltrimethoxysilane, decyltrimethoxysilane, undecyltrimethoxysilane, dodecyltrimethoxysilane, and hexadecyltrimethoxysilane.

The reactions take place in accordance with common methods typically in the temperature range from 0° C. to 200° C., preferably from 20° C. to 120°, with the initial introduction of one component, for example, the silane S, and with the metered introduction of the other component, for example, the polyhydroxy compound P, or by parallel metering of both components, which is conducive to a continuous regime. It is possible here—especially when using solids—to use solvents. In order to accelerate the reaction, especially that of hydrocarbyltrihydrocarbyloxy silanes, it is possible to use catalysts such as acids (e.g., hydrochloric acid, sulfuric acid, acetic acid, phosphoric acid, ammonium salts) or bases (e.g., sodium methoxide, sodium hydroxide, potassium hydroxide, potassium fluoride). If hydrogen halide is eliminated, it can be easily removed in gas form from the reaction mixture and passed on for utilization. If an alcohol elimination product is formed, it can easily be removed by distillation, provided this is permitted by the difference in boiling point with the reactants, and likewise passed on for utilization—for example, for renewed use as a raw material for the preparation of the hydrocarbyltrihydrocarbyloxy silane.

Generally, but preferably when using substoichiometric amounts of OH in relation to halo or hydrocarbyloxy radical in silane S, water may be added to the reaction mixture, in order to minimize the proportion of residual halo or hydrocarbyloxy radicals in the organosilicon compound O. The solid organosilicon compounds O obtainable via this process variant are likewise provided by the invention. They are prepared by reaction of a silane S as defined above with polyhydroxy compounds P in a molar ratio for which per mol equivalent of halo or hydrocarbyloxy radical there are 0.3 to 1.3 mol equivalents of hydroxyl radicals present, there being present at the same time a water fraction which is at least sufficient to hydrolyze the halo or hydrocarbyloxy radicals still remaining theoretically on quantitative conversion of the polyhydroxy compound P, but not exceeding 2 mol equivalents per mol equivalent of halo or hydrocarbyloxy radical.

In order to improve heat transfer, an inert solvent is preferably added, selected more particularly from the group of hydrocarbons such as alkanes, aromatics, and alkylaromatics. Preferred more particularly are substances or compositions which form an azeotrope with water and/or with the alcohol that is liberated, and which therefore facilitate the removal of the alcohol and/or facilitate drying.

In the organosilicon compound O, the concentrations of remanent halo radicals are preferably below 1 wt %, more preferably below 0.1 wt %, and the concentration of the hydrocarbyloxy radicals is preferably below 35 mol %, more preferably below 25 mol %, more particularly below 10 mol %, based on mol of Si.

When hydrocarbyltrihydrocarbyloxy silane is used as silane S and a hydroxycarboxylic acid as polyhydroxy compound P, the acid and the alcohol that is liberated may form an ester during the reaction. In that case, the stoichiometry of the reactants that is employed does not correspond exactly to the molar ratio in the organosilicon compound O. This takes place, however, to only a minor degree and, particularly if the profile of properties impairs the application, can be compensated by appropriate adaptation of the molar ratios of the input materials. The ester possibly formed either may be distilled off during the drying operation, or remains in the reaction mixture. Esterification can be suppressed by varying the reaction conditions, such as temperature and pressure. In order to keep down the concentration of the liberated alcohol in the reaction mixture, the reaction is carried out preferably under reduced pressure and/or at elevated temperature, thereby permanently removing the alcohol from the equilibrium.

Incomplete conversion as well causes a change in the molar ratio in the organosilicon compound O relative to the ratio in which the reactants are employed. This is easily corrected, if necessary, by the skilled person, through a change to the reaction conditions, such as molar ratios, temperature, reaction time.

In the application, in the substrate, silicone resin networks are formed from organosilicon compounds O, and result in the pronounced hydrophobicity. With the organosilicon compounds O and the substrates to be hydrophobized, preference is given to producing building material mixtures which are preferably in powder form. The building material mixtures are based preferably on cement and/or gypsum. These building material mixtures are preferably processed in situ on building sites. The building material mixtures include, for example, interior and exterior renders, filling compounds, cement-based adhesives, such as tile adhesives and other adhesives, screeds, and stucco plaster.

The organosilicon compounds O may also be used, however, for the hydrophobic treatment of finished articles, by being added to the crude mixture during the production operation. Examples thereof are conveyor-line gypsum, particularly for the production of gypsum plasterboard, gypsum fiberboard, cement fiberboard, architectural facing elements, and gypsum wall panels. Particular preference is given to use in gypsum-based building materials. The organosilicon compounds O are highly efficient hydrophobizing agents and, in proportions even of less than one weight percent in the building material mixture, result in a reduction in DIN EN 520 water absorption to less than 5 wt %.

The solid organosilicon compounds O either may be used as the substance per se for body-hydrophobization, or are used in preparations together with other components. They are preferably mixed as a solid into the solid building material to be hydrophobized (dry-mix application). They develop their activity when mixed with water immediately prior to processing. At their most simple, the preparations in question are aqueous, cement-based or gypsum-based dispersions or suspensions, and also gypsum-based slurries in production operations for gypsum articles that comprise at least one organosilicon compound O and water. Such preparations may also comprise the hydrophobizing agents customarily used, such as the silanes, siloxanes, siliconates, and silicates recited in the texts cited above, and also, optionally, additional emulsifiers.

Aqueous, nonaqueous, or solvent-based preparations are obtained by combining the organosilicon compounds O with other constituents, these combinations not automatically producing homogeneous mixtures.

Possible components which may serve for producing preparations for performing the process of the invention are, for example,
H-siloxane,
alkoxy- and aryloxysilanes which may additionally have organofunctional radicals or alkyl or aryl radicals, and also the hydrolysates and condensates obtainable therefrom, and also mixtures of these,
alkyl or aryl siliconates,
sodium or potassium waterglass,
polydimethylsiloxane oils which, instead of one or more methyl groups, may carry other organic groups, such as hydrocarbyl radicals other than methyl radicals; in these hydrocarbyl radicals, the carbon chain may be interrupted as a result of the incorporation of heteroatoms such as S, N, O, P, etc., or else organic functionalities may be present;
silicone resins,
one or more organic solvents, such as aromatic solvents, ketones, esters, alcohols, aliphatic and cycloaliphatic solvents, ionic liquids, and glycols,
water,
organic surfactants,
organic polymers, such as polyvinyl alcohol, polyvinyl acetate, polyacrylates, styrene acrylate copolymers, polyvinylbutyrals, polyurethanes, and polyepoxides,
linear and branched, optionally organically functionalized, polyhydroxylated hydrocarbons, such as ethylene glycol, diethylene glycol, propylene glycol, dipropylene glycol, and higher glycols, sugars such as glycoses, mannoses, and hexoses,
cement
gypsum
lime
   or combinations of the components listed; apart from the components listed here, it is also possible for others to be used of the kind that may be used for producing building material preparations.

It is not absolutely necessary here for the components whose mixing is intended to be able to be processed into a homogeneous, uniform active ingredient mixture. Optionally, multiphase mixtures composed of a plurality of liquid phases or of solid and liquid phases may be formed, and the consistency of the resulting products may be that of a low-viscosity fluid or a paste or cream, or else that of a powder. The preparations are preferably pastelike or solid, more preferably solid.

The organosilicon compounds O are not basic; the pH is less than 10. The organosilicon compounds O can therefore be used to obtain preparations for hydrophobizing building materials that are not basic. Not basic means that on contact with water, the preparations reach a pH of less than 10.

For the hydrophobization of basic building materials such as, for instance, fiber cement, concrete, basic gypsums, etc., it is not necessary for the preparations themselves to comprise a basic activator. In neutral substrates such as gypsum, a basic activator may be used for the rapid development of the hydrophobicity. In that case the basic component may be incorporated into the preparation itself, and may optionally be masked within the preparation in such a way that it is released only in the subsequent application, or it is used without further modification in the preparation, if the usefulness of the preparation is not restricted as a result. This basic component need not itself possess a hydrophobizing effect. It is required only in catalytic amounts. Customary amounts for the use of the basic component for activation are in the range of 0.01-5.0 weight percent, based on mass of organosilicon compound O employed, and selected according to the desired rapidity of the development of the hydrophobicity and/or according to the extent of the catalytic effect of the respective component. Examples of basic activators are quicklime or slaked lime, alkali metal or alkaline earth metal hydroxides, cements, organic amine compounds, alkali metal silicates, and alkali metal siliconates. Likewise employable are acidic activators, corresponding examples being organic carboxylic acids or ammonium compounds.

The preparations are used preferably in the form of an aqueous preparation, a dispersion or suspension. To produce aqueous preparations, surfactants can be used, or else they can be prepared without addition of surfactants, by introducing the organosilicon compounds O directly into water. The production of aqueous preparations without the use of surfactants is possible especially when the organosilicon compounds O are self-emulsifying in water.

All of the above symbols in the above formulae have their definitions in each case independently of one another. In all formulae the silicon atom is tetravalent.

In the inventive and comparative examples below, unless indicated otherwise in each case, all quantity figures and percentage figures are given by weight, and all reactions are carried out under a pressure of 0.10 MPa (abs.).

### PREPARATION EXAMPLE 1

### Reaction Product of Methyltrimethoxysilane and Propylene Glycol (Propane-1,2-Diol) (1:1.5=>(Propylene Glycol)OH:MeO=1.0)

In a 500 ml 5-neck round-bottom flask rendered inert with nitrogen and equipped with paddle stirrer, dropping funnel, thermometer, and water separator with reflux condenser, a solution of 50 g (0.36 mol) of methyltrimethoxysilane (available commercially from Wacker Chemie AG) in 100 g of Isopar E (isoparaffinic hydrocarbon mixture with a boiling range of 113-143° C., available commercially from ExxonMobil) is heated to reflux. The water separator is filled to the brim with Isopar E. With stirring, 41.2 g (0.54 mol) of propylene glycol (=1,2-propanediol, available commercially from Sigma Aldrich) are metered in over 16 minutes. The mixture is heated at reflux for 30 minutes. In the course of this heating, the boiling point drops from 90° C. to 77° C. The distillate separates out as the lower phase in the water separator. Up to a boiling temperature of 118° C., 42.9 g of clear, colorless distillate are collected, which according to analysis by gas chromatography contains 71.4% methanol, 4.5% methyltrimethoxysilane, and 21.2% Isopar E. Taking account of the amount of methyltrimethoxysilane recovered, 91% of the methoxy radicals in the methyltrimethoxysilane have been eliminated, and the molar silane/glycol ratio is therefore 1:1.56. Settling out of the reaction mixture during the distillation is a pastelike white solid, which is subsequently dried to constant weight in the flask at 100° C./5 mbar. 51 g of fine, white, free-flowable powder is isolated, whose solids content is 55% (determined using the HR73 Halogen Moisture Analyzer solids-content balance from Mettler Toledo at 160° C.).

A 10% suspension in water is prepared (1 g of solid in 9 g of water), and is stirred at 22° C. for about 10 minutes and filtered through a 5 μm filter. The solids content of the filtrate, determined by to the method stated above, is 0.34% (meaning that 5% of the solid has dissolved).

### PREPARATION EXAMPLE 2

### Reaction Product of Methyltrimethoxysilane, Glycerol (Propane-1,2,3-Triol), and Water (1:0.5:1=>(Glycerol)OH:OMe=0.5)

In a 500 ml 5-neck round-bottom flask rendered inert with nitrogen and equipped with paddle stirrer, dropping funnel, thermometer, and reflux condenser, a mixture of 69.3 g (0.5 mol) of methyltrimethoxysilane (available commercially from Wacker Chemie AG) and 100 g of methanol is heated to reflux. Metered in with stirring over 10 minutes is a solution of 23.3 g (0.25 mol) of glycerol (available commercially from Aldrich) and 4.5 g (0.25 mol) of demineralized water. The mixture is held at reflux (66° C.) for an hour. Then a water separator is installed between the flask and the reflux condenser, and is filled with cyclohexane (available commercially from Merck). 185 g of cyclohexane are added to the mixture, which is heated to boiling (75° C.). In the water separator, the distillate separates into an upper phase and a lower phase. A total of 188.7 g of lower phase are obtained. According to analysis by gas chromatography, this phase contains 63.6% methanol, 2.7% methyltrimethoxysilane, and 33.6% cyclohexane. The residue is admixed with 160 g of cyclohexane, 4.5 g (0.25 mol) of demineralized water, and 0.2 g of concentrated hydrochloric acid. It is heated at reflux (79° C.) on a water separator. The distillate separates into an upper phase and a lower phase in the water separator. A total of 16 g of lower phase are obtained. According to analysis by gas chromatography, it contains 83% methanol, 9.1% water and 7.8% cyclohexane. Taking account of the amount of methyltrimethoxysilane recovered, 75% of the methoxy radicals in the methyltrimethoxysilane have been eliminated, and the molar silane/glycerol ratio is therefore 1:0.54. In the course of distillation, the reaction mixture forms a white suspension, which is evaporated to dryness at 100° C./1 hPa. 48.7 g of fine, white, free-flowable powder are isolated, whose solids content is 80.2% (determined using the HR73 Halogen Moisture Analyzer solids-content balance from Mettler Toledo at 160° C.). A 10% suspension in water is prepared (1 g of solid in 9 g of water), and is stirred at 22° C. for about 10 minutes and filtered through a 5 μm filter. The solids content of the filtrate, determined by the method stated above, is 1.9% (meaning that 23% of the solid has dissolved).

Elemental analysis of the solid gives 23.2% Si, 28% C, and 6.5% H, corresponding for example approximately to the following formula:

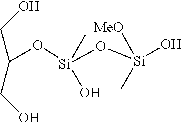

### PREPARATION EXAMPLE 3

### Reaction Product of Methyltrimethoxysilane, Lactic Acid (2-Hydroxypropionic Acid), and Water (1:1.5:1.3=>(Lactic Acid)OH:MeO=1.0)

In a 500 ml 5-neck round-bottom flask which is rendered inert with nitrogen and equipped with paddle stirrer, dropping funnel, thermometer, and water separator with reflux condenser, 50 g (0.36 mol) of methyltrimethoxysilane (available commercially from Wacker Chemie AG) and 100 g of Isopar E (isoparaffinic hydrocarbon mixture with a boiling range of 113-143° C., available commercially from ExxonMobil) are introduced as an initial charge at 50° C. The water separator is filled to the brim with Isopar E. With stirring, 56.7 g (0.54 mol) of lactic acid (85% form, available commercially from Sigma, containing 8.5 g (0.47 mol) of water) are metered in over 11 minutes. During this addition, the mixture heats up to 62° C. It is heated at reflux for half an hour, after which distillate is taken off, and separates into two liquid phases in the water separator. Up to a boiling temperature of 116° C., 48.5 g of clear, colorless distillate are collected as the lower phase, and according to analysis by gas chromatography this phase contains 60.9% methanol, 10% lactic acid, 25.6% methyl lactate, and 3.2% Isopar E. Accordingly, 96% of the methoxy radicals present in the methyltrimethoxysilane have been eliminated in the form of methanol or methyl lactate. A white solid precipitates from the reaction mixture in the course of the distillation. Removal of the volatile constituents by stripping leads to 52.2 g of fine, white, free-flowable powder, whose solids content is 60% (determined using the HR73 Halogen Moisture Analyzer solids-content balance from Mettler Toledo at 160° C.). The amount and composition of the distillate indicate a molar MeSiO_{3/2}:lactic acid ratio of 1:1, i.e. (lactic acid)OH:MeSi=0.67.

According to elemental analysis, the powder contains 18.9 wt % silicon, which fits well with the following average formula:

MeSi(O_{2/2})(OH)(CH₃CH(O_{1/2})COO_{1/2}).

A 10% suspension in water is prepared (1 g of solid in 9 g of water), and is stirred at 22° C. for about 10 minutes and filtered through a 5 μm filter. The solids content of the filtrate, determined by the method stated above, is 2.47% (meaning that 35% of the solid has dissolved).

### PREPARATION EXAMPLE 4

### Reaction Product of Methyltrimethoxysilane, Glycerol (Propane-1,2,3-Triol), and Water (1:0.33:2=>(Glycerol)OH:MeO=0.33)

In a 500 ml 5-neck round-bottom flask rendered inert with nitrogen and equipped with paddle stirrer, dropping funnel, thermometer, and reflux condenser, a mixture of 69.3 g (0.5 mol) of methyltrimethoxysilane (available commercially from Wacker Chemie AG) and 100 g of methanol is heated to reflux. Metered in with stirring over 10 minutes is a solution of 15.3 g (0.165 mol) of glycerol (available commercially from Aldrich) and 18 g (1 mol) of demineralized water. The mixture is held at reflux (67° C.) for two hours. Then a water separator is installed between the flask and the reflux condenser, and is filled with Isopar E (isoparaffinic hydrocarbon mixture with a boiling range of 113-143° C., available commercially from ExxonMobil). 208 g of Isopar E are added to the mixture, which is heated to boiling. In the water separator, the distillate separates into an upper phase and a lower phase. Up to a boiling temperature of 119° C., 179.5 g of lower phase are obtained. According to analysis by gas chromatography, it contains 88.4% methanol, 7.4% Isopar E and 4.2% water. Accordingly, the methoxy radicals have been eliminated quantitatively. In the course of distillation, the reaction mixture forms a white suspension, which is evaporated to dryness at 100° C./1 hPa. 53.3 g of fine, white, free-flowable powder are isolated, whose solids content is 83.3% (determined using the HR73 Halogen Moisture Analyzer solids-content balance from Mettler Toledo at 160° C.).

A 10% suspension in water is prepared (1 g of solid in 9 g of water), and is stirred at 22° C. for about 10 minutes and filtered through a 5 μm filter. The solids content of the filtrate, determined by the method stated above, is 0.28% (meaning that 3.3% of the solid has dissolved).

### PREPARATION EXAMPLE 5

### Reaction Product of Methyltrimethoxysilane, Lactic Acid (2-Hydroxypropionic Acid), and Water (1:0.95:1.5=>(Lactic Acid)OH:MeO=0.63)

In a 500 ml 5-neck round-bottom flask conditioned to 60° C. by means of an oil bath and equipped with paddle stirrer, two dropping funnels, thermometer, and top-mounted distillation assembly, a vacuum pump is used to set a pressure of 300 hPa. A solution of 35.9 g (0.34 mol) of lactic acid (85% form, available commercially from Sigma, containing 5.4 g (0.3 mol) of water) and 4.4 g (0.24 mol) of water is metered into the flask over 45 minutes in parallel with 50 g (0.36 mol) of methyltrimethoxysilane (available commercially from Wacker Chemie AG) from the two dropping funnels, with stirring. The volatile constituents collect in the receiver, while the residue becomes increasingly viscous. After the end of metering, drying takes place under full vacuum (5 hPa) for an hour. 37.4 g of clear, colorless distillate are isolated, and according to analysis by gas chromatography contain 91.3% methanol (=98.5% of the theoretical amount), 4.1% methyl lactate (=4.3% of the lactic acid used), and 4.1% water, and, as a residue, 52.3 g of finely particulate white powder with a solids content of 57.6% (determined using the HR73 Halogen Moisture Analyzer solids-content balance from Mettler Toledo at 160° C.). The amount and composition of the distillate indicate a molar MeSiO_{3/2}:lactic acid ratio of 1:0.91, i.e. (lactic acid)OH:MeSi=1.1.

In the application examples which follow, standard commercial gypsum plasters or gypsum filling compounds in powder form (Goldband light finishing plaster, MP 75 machine-application plaster, and Uniflott filling compound from Knauf Gips KG, Iphofen, Germany) were mixed effectively with varying amounts of the organosilicon compounds O from the above-described preparation examples in dry form. These dry mixes were subsequently added in portions and with stirring to the mixing water, in accordance with the recipe indicated on the pack, and the water and the mix were stirred together using an electrically operated paddle stirrer at moderate speed, to form a homogeneous slurry (Goldband light finishing plaster: 300 g gypsum powder and 200 g water; MP 75 machine-application plaster: 300 g gypsum powder and 180 g water; Uniflott filling compound: 300 g gypsum powder and 180 g water—in each case as per pack instructions). The resulting slurry was then poured into PVC rings (diameter: 80 mm, height 20 mm) and the gypsum was cured at 23° C. and 50% relative atmospheric humidity over 24 hours. Demolding of the gypsum test specimens from the rings was followed by drying of the test specimens to constant weight in a forced-air drying cabinet at 40° C. For the determination of the water absorption in accordance with DIN EN 520, the test specimens, following determination of the dry weight, were stored under water for 120 minutes, with the samples placed horizontally on metal grids, and with the water level above the highest point of the test specimens being 5 mm. After 120 minutes, the test specimens were taken from the water and allowed to drip off on a water-saturated sponge, and the percentage water absorption was calculated from the wet weight and the dry weight in accordance with the following formula

Percentage water absorption={[Mass(wet)−Mass(dry)]/Mass(dry)}·100%.

### APPLICATION EXAMPLE 1

### Hydrophobization of a Gypsum Filling Compound (Knauf)UNIFLOTT® with a 1:1.5 Reaction Product of Methyltrimethoxysilane and Propylene Glycol (Product from Preparation Example 1).

Table 1 shows that at least from a level of addition of 0.6 wt % onward, the water absorption of the two gypsum plasters is below the 5 wt % limit. The product from preparation example 1, however, is particularly suitable for gypsum filling compounds—here, the water absorption is below the 5 wt % limit at even the lowest level of addition, of 0.2 wt %.

### APPLICATION EXAMPLE 2

### Hydrophobization of Two Gypsum Plasters with a 1:0.5:1 Reaction Product of Methyltrimethoxysilane, Glycerol (Propane-1,2,3-Triol), and Water (Product from Preparation Example 2)

Table 1 shows that a reaction product of methyltrimethoxysilane, glycerol, and water likewise hydrophobizes gypsum plasters very efficiently. Water absorption is below 5 wt % in this case at a level of addition of just 0.4%.

### APPLICATION EXAMPLE 3

### Hydrophobization of Two Gypsum Plasters with a 1:1.5:1.3 Reaction Product of Methyltrimethoxysilane, Lactic Acid (2-Hydroxypropionic Acid), and Water (Product from Preparation Example 3)

A reaction product of methyltrimethoxysilane with lactic acid and water proves to be a highly efficient and particularly effective hydrophobizing agent in the two different gypsum plasters. As is evident from table 1, water absorption in this example is below 2% at a level of addition of just 0.2 wt % upward, depending on the gypsum plaster used.

### APPLICATION EXAMPLE 4

### Hydrophobization of Two Gypsum Plasters with a 1:0.33:2 Reaction Product of Methyltrimethoxysilane, Glycerol (Propan-1,2,3-Triol), and Water (Product from Preparation Example 4)

In the case of preparation example 4, the amount of glycerol used was reduced as compared with preparation example 2. The efficiency of hydrophobization is lower than in application example 2—in the case of the manual plaster, water absorption does not fall below 5 wt % even at a level of addition of 0.6%.

### APPLICATION EXAMPLE 5

### Comparative Example, Not Inventive

A comparison with the common dry-mix hydrophobizing additive SILRES® POWDER G (Wacker Chemie AG) makes clear the difference relative to products commercially available at present. 10% capillary water absorption by the manual gypsum plaster is achieved only by a 1.4% level of addition of SILRES® POWDER G; capillary water absorption is below 5% with 1.6% of SILRES® POWDER G.

### APPLICATION EXAMPLE 6

### Hydrophobization of a Gypsum Plaster with a 1:0.95:1.5 Reaction Product of Methyltrimethoxysilane, Lactic Acid (2-Hydroxypropionic Acid), and Water (Product from Preparation Example 5)

In the case of preparation example 5, the amount of lactic acid used was reduced as compared with preparation example 3. The efficiency of hydrophobization is lower than in application example 3: water absorption in the case of the manual plaster falls below 5 wt % only for a level of addition of 0.6%.

Table 1 reports the water absorption of gypsum test specimens in accordance with DIN EN 520

TABLE 1

| | WATER ABSORPTION IN WT % | | | | | |
|---|---|---|---|---|---|---|
| | (level of addition in wt % in brackets) | | | | | |
| Additive from | | | Test substrate: | | | |
| preparation | | | Knauf MP 75 | | | |
| example, | Test substrate: | | lime-gypsum | | Test substrate: | |
| untreated | Knauf Uniflott | | machine- | | Knauf Goldband | |
| (without | gypsum filling | | application | | lime-gypsum | |
| additive) | compound | | plaster | | manual plaster | |
| | 16.3 | (0.0) | 39.9 | (0.0) | 36.3 | (0.0) |
| 1 | 4.9 | (0.2) | 30.7 | (0.2) | 22.0 | (0.2) |
| | 2.8 | (0.4) | 14.3 | (0.4) | 12.7 | (0.4) |
| | 2.2 | (0.6) | 2.2 | (0.6) | 3.0 | (0.6) |
| 2 | | | 7.3 | (0.2) | 12.7 | (0.2) |
| | | | 2.1 | (0.4) | 4.3 | (0.4) |
| | | | 2.2 | (0.6) | 1.5 | (0.6) |
| 3 | | | 1.7 | (0.2) | 5.8 | (0.2) |
| | | | 2.0 | (0.4) | 1.1 | (0.4) |
| | | | 2.1 | (0.6) | 1.1 | (0.6) |
| 4 | | | 21.8 | (0.2) | 36.3 | (0.2) |
| | | | 4.7 | (0.4) | 29.6 | (0.4) |
| | | | 2.2 | (0.6) | 6.7 | (0.6) |
| 5* | | | | | 10.7 | (1.4) |
| | | | | | 3.2 | (1.6) |
| | | | | | 1.6 | (1.8) |
| 6 | | | | | 34.9 | (0.2) |
| | | | | | 17.1 | (0.4) |
| | | | | | 1.5 | (0.6) |

*not inventive

1.-12. (canceled)

13. A process for the body-hydrophobization of substrates with organosilicon compounds O which are solid at 20° C. and prepared by a process comprising reacting a molar equivalent of at least one silane S which is a hydrocarbyltrihalosilane, hydrocarbyltrihydrocarbyloxysilane, mixture thereof, or partial hydrolysate thereof, with at least one polyhydroxy compound P, in a molar ratio such that per mol equivalent of halo or hydrocarbyloxy radicals there are 0.3 to 1.3 mol equivalents of hydroxyl radicals.

14. A process for preparing organosilicon compounds O which are solid at 20° C., comprising reacting a molar equivalent of at least one silane S which is a hydrocarbyltrihalosilane, hydrocarbyltrihydrocarbyloxysilane, mixture thereof, or partial hydrolysate thereof, with at least one polyhydroxy compound P, in a molar ratio such that per mol equivalent of halo or hydrocarbyloxy radicals there are 0.3 to 1.3 mol equivalents of hydroxyl radicals,
there being present at the same time a water fraction which is at least sufficient to hydrolyze halo or hydrocarbyloxy radicals still remaining on quantitative conversion of the polyhydroxy compound P, but not exceeding 2 mol equivalents per mol equivalent of halo or hydrocarbyloxy radical.

15. An organosilicon compound O obtained by the process of claim 14.

16. The process of claim 13, wherein the hydrocarbyl radicals of the silane S are substituted or unsubstituted C₁-C₁₅ hydrocarbyl radicals.

17. The process of claim 14, wherein the hydrocarbyl radicals of the silane S are substituted or unsubstituted C₁-C₁₅ hydrocarbyl radicals.

18. The process of claim 13, wherein the hydrocarbyloxy radicals of the silane S are unsubstituted C₁-C₃ alkyl radicals.

19. The process of claim 14, wherein the hydrocarbyloxy radicals of the silane S are unsubstituted C₁-C₃ alkyl radicals.

20. The process of claim 16, wherein the hydrocarbyloxy radicals of the silane S are unsubstituted C₁-C₃ alkyl radicals.

21. The process of claim 13, wherein the halo radicals of the silane S are chloro radicals.

22. The process of claim 14, wherein the halo radicals of the silane S are chloro radicals.

23. The process of claim 13, wherein the polyhydroxy compound P comprise linear or branched monomeric or oligomeric C₂-C₆ glycol or mixtures thereof, tri-, tetra-, penta-, or hexa-hydroxy compound(s) having 3 to 12 carbon atoms, or C₂-C₁₂ hydroxycarboxylic acid(s).

24. The process of claim 14, wherein the polyhydroxy compound P comprise linear or branched monomeric or oligomeric C₂-C₆ glycol or mixtures thereof, tri, tetra-, penta-, or hexa-hydroxy compound(s) having 3 to 12 carbon atoms, or C₂-C₁₂ hydroxycarboxylic acid(s).

25. A mixture of mineral building materials containing at least one organosilicon compound O of claim 13.

26. A process for the preparation of a body-hydrophobicizing water-curable mineral building material, comprising mixing mineral building material in solid form with at least one organosilicon component O of claim 13.

27. A process for the preparation of a body-hydrophobicizing water-curable mineral building material, comprising mixing mineral building material in solid form with at least one organosilicon component O of claim 14.

28. The mixture of claim 25, wherein the mineral building material to be hydrophobized is cement, gypsum, or a mixture thereof.

29. The mixture of claim 16, wherein the mineral building material to be hydrophobized is cement, gypsum, or a mixture thereof.

30. The mixture of claim 25, which is an interior or exterior render, filling compound, adhesive, screed, or stucco plaster.

31. The mixture of claim 26, which is an interior or exterior render, filling compound, adhesive, screed, or stucco plaster.
